(19) United States
(12) Patent Application Publication
(10) Pub. No.: US 2007/0082532 A1
(43) Pub. Date: Apr. 12, 2007

(54) One touch connection and disconnection method and apparatus

(76) Inventor: Ronald Edward Morris, New London, NH (US)

Correspondence Address: PROSKAUER ROSE LLP, ONE INTERNATIONAL PLACE 14TH FL, BOSTON, MA, 02110, US

(21) Appl. No.: 11/248,717

(22) Filed: Oct. 11, 2005

(51) Int. Cl. H01R 13/627

(52) U.S. Cl. 439/352

(57) ABSTRACT

A first connector is disposed on a housing associated with a power supply for a plasma arc system or on a lead for a plasma arc torch. The first connector is adapted to mate with a second connector along a longitudinal axis. A locking member causes, upon application of a translational force, engagement of the first connector and second connector. Upon application of a linear force at an angle relative to the longitudinal axis, the locking member causes disengagement of the first connector and second connector. Methods for connecting and disconnecting a torch lead are also disclosed.

### FIELD OF THE INVENTION

The invention relates generally to a connector for a tool. More particularly, the invention relates to a connector for a plasma arc system.

### BACKGROUND OF THE INVENTION

Plasma arc torches are widely used in the cutting or marking of metallic materials. A plasma torch generally includes an electrode and a nozzle having a central exit orifice mounted within a torch body, electrical connections, passages for cooling, passages for arc control fluids, and a power supply. Optionally, a swirl ring is employed to control fluid flow patterns in the plasma chamber formed between the electrode and nozzle. The torch produces a plasma arc, a constricted ionized jet of a gas with high temperature and high momentum. Gases used in the torch can be non-reactive (e.g., argon or nitrogen), or reactive (e.g., oxygen or air).

In operation, a pilot arc is first generated between the electrode (cathode) and the nozzle (anode). Generation of the pilot arc can be by means of a high frequency, high voltage signal coupled to a DC power supply and the torch or any of a variety of contact starting methods.

One known configuration of a plasma arc torch includes one or more leads connecting the torch to the power supply to provide the torch with electrical current and fluid. The engagement of the lead(s) to the power supply must be rugged to handle the stress and/or the strain placed on the lead as it is manipulated in order to place the plasma arc torch in a position to cut or mark a workpiece. The lead(s) used to connect the torch to the power supply can be a single integral lead having a fluid hose, for example, a gas hose located in the middle of the lead and electrical conductors and fillers arranged symmetrically around the gas hose. A jacket material is extruded over the gas hose, electrical conductors, and fillers. Alternatively, multiple leads attach to the power supply, for example, four fluid leads, two having cooling liquid and two having gas, attach to the power supply.

Previous connections for connecting the leads to the power supply can have any of several limitations. Some lead connections require large access areas, which impact power supply size. Certain connectors must be visible to enable engagement and/or disengagement, which impacts lead placement, space, can necessitate lighting, and can increase the time required to engage and disengage the lead connections. Other connectors require the operator to use two hands to complete the engagement and/or disengagement. Adequate space about the power supply and the leads must be available to enable two hands to access the connection. Some known connections require use of one or more tools to enable engagement and/or disengagement. The use of a tool can be time consuming, the tool can be easily misplaced, and space must be available on the power supply and/or adjacent the connector to accommodate the tool. Threaded connector fittings can be incorrectly installed and tightened causing wear and/or leaking. Certain connectors and/or leads leak after multiple or frequent engagements and disengagements.

In certain plasma arc systems, the flow of fluid through the power supply must be stopped before leads are removed. Otherwise, when a lead is removed from the power supply, fluids, for example liquid and gas, continue to flow through the power supply creating a mess, wasting fluids, and risking a slip and fall hazard. Even when the fluid flow has been stopped, liquid remaining in a removed liquid lead sometimes spills on, for example, an operator's hands or about the work area risking a safety hazard.

It is therefore an object of the present invention to provide an improved connection for a lead to a plasma arc torch power supply.

### SUMMARY OF THE INVENTION

In one aspect, the invention relates to a power supply for a plasma arc system that includes a housing associated with the power supply. A first connector is disposed relative to the housing and is adapted to mate with a second connector along a longitudinal axis. A locking member causes, upon application of a translational force, engagement of the first connector and the second connector. Application of a linear force to the locking member at an angle relative to the longitudinal axis causes disengagement of the first connector and second connector. The linear force can be applied at an angle that ranges from about 0° to about 180°. In one embodiment, the angle is perpendicular to the longitudinal axis. The power supply can include an opening member to access the first connector, the second connector, or the first connector and the second connector.

In one embodiment, the locking member includes a planar member that is adapted to disengage the first connector and second connector upon application of a linear force applied to the planar member at an angle perpendicular to the longitudinal axis. The locking member can be integral to the first connector or, alternatively, the locking member can be integral to the second connector.

The power supply can include a third connector disposed relative to the housing that is adapted to mate with a fourth connector along a longitudinal axis. Application of a translational force to a second locking member causes engagement of the third connector and forth connector. The second locking member causes, upon application of a linear force at an angle relative to the longitudinal axis, disengagement of the third connector and the fourth connector.

The first connector can be, for example, a female connector or a male connector. In one embodiment, the first connector is a female connector and the third connector is a male connector. Optionally, the first connector defines a fluid passageway and is configured to prevent flow through the fluid passageway when the first connector is disengaged.

In another aspect, the invention relates to a lead for a plasma arc torch. The lead includes an elongated body, a first end, and a second end. A second connector is disposed on the second end of the lead and a locking member causes, upon application of a translational force along a longitudinal axis, engagement of the second connector and a first connector. As described above, applying a linear force to the locking member at an angle relative to the longitudinal axis causes disengagement of the first connector and the second connector. The locking member can include a planar member, can be integral to the first or the second connector. The second connector can be a female connector, can be a male connector, can define a fluid passageway, and/or is optionally configured to prevent flow through the fluid passageway when the second connector is disengaged.

In another aspect, the invention relates to a plasma arc torch system including a torch body, a power supply, a lead including an elongated body, a first end, and a second end. The first end is connected to the torch body. A connector assembly connects the second end of the lead with the power supply. In one embodiment, the torch body includes a nozzle mounted at a first end of the torch body. In another embodiment, an electrode is mounted at a first end of the torch body. The electrode can be in a mutually spaced relationship with the nozzle to define a plasma chamber. In another embodiment, a retaining cap is mounted on the torch body. The retaining cap can substantially enclose the outer surface of the nozzle. In another embodiment, the torch body also includes a shield having a central circular opening that is aligned with the nozzle. In another embodiment, a positive rotational restraint component is disposed on the elongated body of the lead and the second end of the lead is disposed on the power supply. The positive rotational restraint component restrains rotational movement of the lead relative to the power supply.

In another aspect, the invention relates to a method for connecting and disconnecting a torch lead to a power supply for a plasma arc torch. The method includes providing a power supply including a housing, disposing relative to the housing a first connector adapted to mate with a second connector, providing a lead including an elongated body, a first end connected to a torch body, and a second end connected to the second connector, and manipulating the first connector and the second connector relative to a locking member with one of a translational force or a linear force to engage or disengage the first connector and the second connector. In one embodiment, the method includes applying translational force to the second connector along a longitudinal axis and engaging the second connector with the first connector. In another embodiment, the method includes applying with, for example, one or more fingers a linear force to the locking member at an angle relative to a longitudinal axis and disengaging the first connector and the second connector.

In another aspect, the invention relates to a power supply for a plasma arc system that includes a housing associated with the power supply and a first connector disposed relative to the housing. The first connector defines a fluid passageway and is configured to prevent fluid flow through the fluid passageway when the first connector is disengaged from a mated second connector. In one embodiment, the first connector defines a liquid passageway and is configured to prevent flow through the liquid passageway when the first connector is disengaged from a mated second connector. In one embodiment, the first connector includes a valve adapted to open and close the fluid passageway. In another embodiment, a second connector defines a second liquid passageway and is configured to prevent flow through the second liquid passageway when the second connector is disengaged from the first connector. In another embodiment, a third connector is disposed relative to the housing and is adapted to mate with a fourth connector. The power supply can include an opening member to access the connectors and/or the connector assemblies. In one embodiment, the third connector defines a gas passageway and is, for example, configured to prevent flow through the gas passageway when the third connector is disengaged from the fourth connector. Optionally, the fourth connector defines a second gas passageway and is configured to prevent flow through the gas passageway when the third and fourth connectors are disengaged. The first connector defines a liquid passageway and the third connector defines a gas passageway. In another embodiment, a fifth connector is disposed relative to the housing. The fifth connector defines a third liquid passageway and is configured to prevent flow through the third liquid passageway when the fifth connector is disengaged from a mated sixth connector. In another embodiment, a seventh connector is disposed relative to the housing and the seventh connector defines a third gas passageway. An eighth connector is adapted to mate with the seventh connector. In one embodiment, the seventh connector defines a third gas passageway and is configured to prevent flow through the third gas passageway when the seventh connector is disengaged from the eighth connector. The eighth connector can define a fourth gas passageway and be configured to prevent flow through the fourth gas passageway when the seventh and eighth connectors are disengaged. In one embodiment, the fifth connector is a female connector and the seventh connector is a male connector.

Optionally, the connectors are designed and/or positioned to avoid incorrect engagement In one embodiment, the first connector and second connector are both disposed on the housing and are a female and a male connector, respectively, as such connection of an incorrect mated connector disposed on, for example, a lead is avoided. In another embodiment, the first connector and the third connector are both disposed on the housing and the first connector has a first color and the third connector has a second color different from the first color. The desired lead and/or connector that mates with the first connector has a first color. Similarly, the desired lead and/or connector that mates with the second connector has a second color. Additional leads and/or connector assemblies can similarly be positioned or designed to avoid incorrect engagement. Suitable designs include, for example, color coding with the same color or complimentary colors. For example, a first connector has a light color and a second connector has a darker shade of the same color or a first connector has a solid color and a second connector features the same color, but in a design such as, for example, stripes. Alternative designs that avoid incorrect engagement include using different connector materials (e.g., plastic and metal) or using differently sized connectors and/or leads.

In another aspect, the invention relates to a lead for a plasma arc torch. The lead includes an elongated body, a first end, and a second end. A second connector is disposed on the second end of the lead. The second connector defines a fluid passageway and is configured to prevent fluid flow through the fluid passageway when the second connector is disengaged from a mated first connector. In one embodiment, the second connector includes a valve adapted to open and close the fluid passageway.

In another aspect, the invention relates to a plasma arc torch system including a torch body, a power supply and a lead. The lead includes an elongated body, a first end connected to the torch body, and a second end. A connector assembly connects the second end of the lead with the power supply. The connector assembly includes a first connector defining a fluid passageway. The first connector is configured to prevent fluid flow through the fluid passageway when the first connector is disengaged from a mated second connector.

In one embodiment, the torch body includes a nozzle mounted at a first end of the torch body. In another embodiment, the torch body includes an electrode mounted at a first end of the torch body in a mutually spaced relationship with the nozzle to define a plasma chamber. In another embodiment, a retaining cap is mounted on the torch body. The retaining cap can, for example, substantially enclose the outer surface of the nozzle. In another embodiment, a shield having a central circular opening aligned with the nozzle. In one embodiment, the lead includes a positive rotational restraint component. The positive rotational restraint component can be disposed on the elongated body and can restrain rotational movement of the lead relative to the power supply. The second end of the lead can be disposed on the power supply.

In another aspect, the invention relates to a method for connecting a torch lead to a power supply for a plasma arc torch. The method includes providing a power supply including a housing, disposing relative to the housing a first connector adapted to mate with a second connector, providing a lead including an elongated body, a first end connected to a torch body, and a second end, disposing on the second end of the lead the second connector defining a fluid passageway and configured to prevent fluid flow through the fluid passageway when the second connector is disengaged from the first connector, and engaging the first connector and the second connector. In one embodiment, the first connector defines a second fluid passageway and is configured to prevent fluid flow through the second fluid passageway when the second connector and the first connector are disengaged.

In another aspect, the invention relates to a power supply for a plasma arc system including a housing means associated with the power supply. A first connector means is disposed relative to the housing and is adapted to mate with a second connector means along a longitudinal axis. A locking means causes, upon application of a translational force, engagement of the first connector means and the second connector means. The locking means causes disengagement of the first connector means and the second connector means upon application of a linear force at an angle relative to the longitudinal axis.

### BRIEF DESCRIPTION OF THE DRAWINGS

FIG. 1 illustrates a connector assembly including a first connector adapted to mate with a second connector along a longitudinal axis.

FIG. 2A illustrates a first connector.

FIG. 2B illustrates a second connector adapted to mate with the first connector of FIG. 2A.

FIG. 3A illustrates a cross section of a first connector illustrated in FIG. 2A adapted to mate along a longitudinal axis with a second connector illustrated in FIG. 2B.

FIG. 3B illustrates a cross section of the first connector illustrated in FIG. 2A engaged with a second connector illustrated in FIG. 2B.

FIG. 4A illustrates a disengaged locking member.

FIG. 4B illustrates an engaged locking member.

FIG. 5A illustrates another embodiment of a connector assembly including a first connector adapted to mate with a second connector along a longitudinal axis.

FIG. 5B illustrates a connector having a raised button.

FIG. 6A is a diagram of multiple leads attached by a connector assembly to a plasma arc torch power supply and a single lead detached from the plasma arc torch power supply.

FIG. 6B is another diagram of multiple leads attached to a plasma arc torch power supply and a single lead detached from the plasma arc torch power supply, a connector disposed on each lead has a mated connector disposed on the power supply.

FIG. 7 illustrates a strain relief system.

FIG. 8 is a diagram of a plasma arc torch power supply, lead, a connector, a strain relief system and a torch body used for cutting or piercing a metal workpiece.

FIG. 9 is a schematic cross-sectional view of a conventional plasma arc torch.

### DETAILED DESCRIPTION OF THE INVENTION

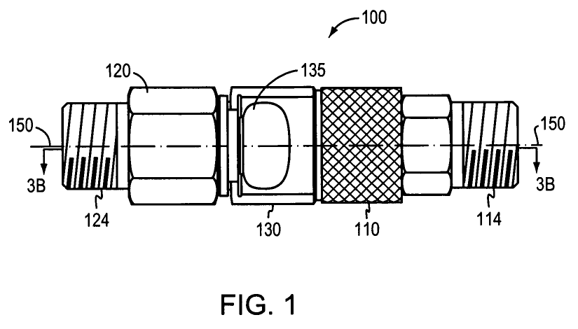

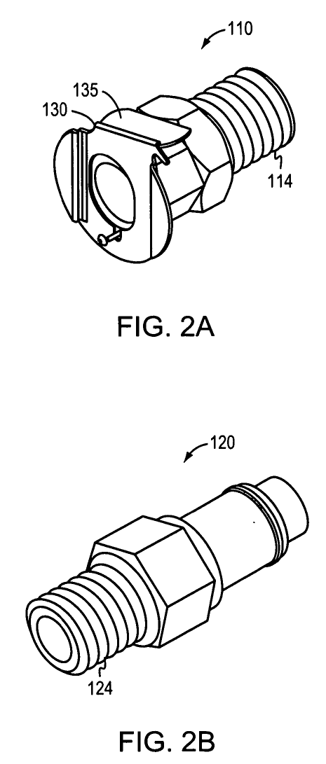

FIG. 1 illustrates a connector assembly 100 that connects a lead to a power supply for a plasma arc system. Referring also to FIGS. 2A-2B, the connector assembly 100 features a first connector 110 and a second connector 120. The first connector 110 is adapted to mate with the second connector 120 along a longitudinal axis 150. The first connector 110 is, for example, a female connector adapted to receive a mated male connector. A first locking member 130 engages the first connector 110 and the mated second connector 120. Similarly, the first locking member 130 disengages the first connector 110 and the second connector 120. In one embodiment, the first locking member 130 is integral to the first connector 110. Alternatively, a locking member can be integral to the second connector 120 (not shown). In another embodiment, a locking member is separate from both the first connector 110 and the second connector 120 (not shown).

The first connector 110 termination 114 is threaded and the second connector 120 termination 124 is also threaded. Other suitable terminations for the connectors and/or the connector assemblies can be in line, in line hose, elbow, barbed terminations, or any other termination suitable for an application employing the connector and/or the connector assembly. Optionally, the terminations 114, 124 are integral to the connectors 110, 120. Alternatively, the terminations 114, 124 are separate from and assemble or join with the connectors 110, 120. Each of the terminations for a connector assembly 100 can be the same, for example, the terminations 114 and 124 are each threaded terminations. Alternatively, one termination 114 is different from another termination 124 on a single connector assembly 110 (not shown), for example, one termination on a connector assembly is threaded and the other termination is in line.

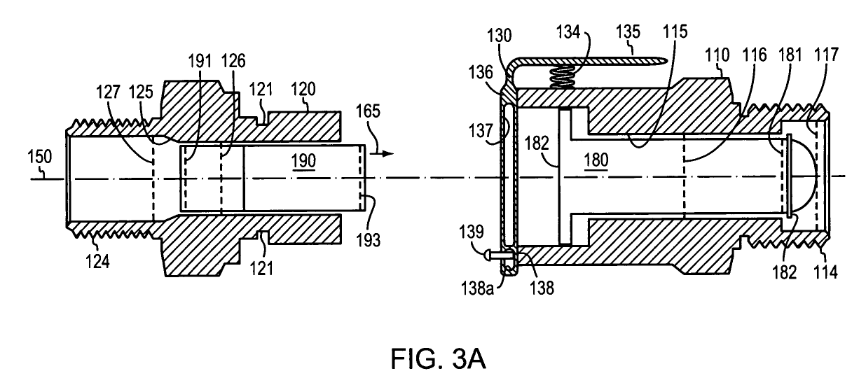

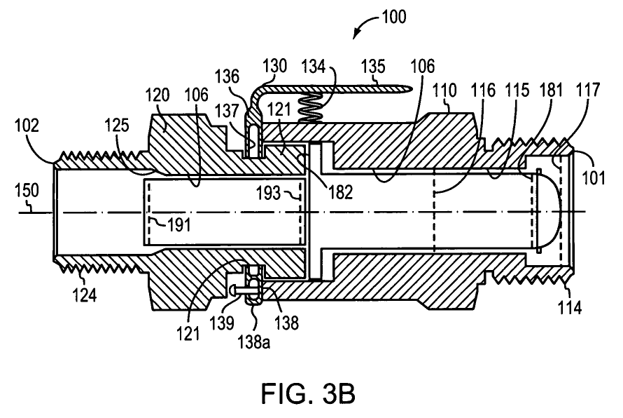

FIG. 3A illustrates a cross section of the first connector 110, the second connector 120, and the first locking member 130. In this illustrative embodiment, the first locking member 130 is integral to the first connector 110. The first connector 110 defines a first fluid passageway 115 and the second connector 120 defines a second fluid passageway 125. A translational force 165 is applied, along the longitudinal axis 150, to the first locking member 130 by the second connector 120. The translational force 165 applied to the first locking member 130 causes engagement of the first connector 110 and the second connector 120. Upon engagement of the first connector 110 and the second connector 120 a connector assembly 100 is formed. FIG. 3B illustrates a cross section of the connector assembly 100. When the connector assembly 100 is formed, the first fluid passageway 115 and the second fluid passageway 125 join to provide a fluid passageway 106 through connector assembly 100. Fluid flows through the connector assembly fluid passageway 106, between the first end 101 and the second end 102. Fluid can flow in either direction, e.g., from the first end 101 toward the second end 102 or, alternatively, from the second end 102 toward the first end 101.

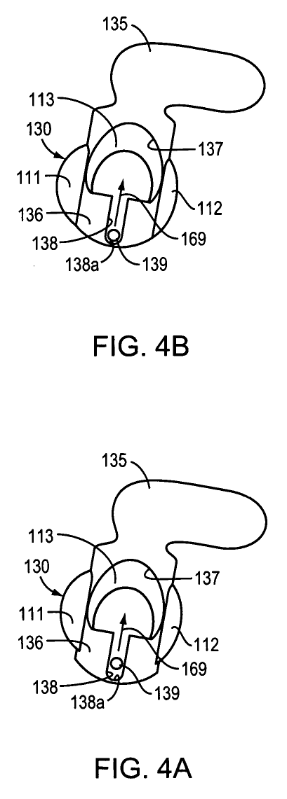

FIG. 4A illustrates an embodiment of a first locking member 130 in the disengaged position and FIG. 4B illustrates an embodiment of a first locking member 130 in the engaged position. The first locking member 130 features a touch position 135, a planar member 136 defining an ellipse 137, optionally, featuring a cleft 138 that splits at least a portion of the ellipse 137. In one embodiment, the first locking member 130 features a leg 139 that retracts and extends.

Referring now to FIGS. 3A-3B and 4A-4B, in one embodiment, the first locking member 130 is integral to the first connector 110. The planar member 136 is adjacent the face of first end 113 of the first connector 110. The planar member 136 is positioned between the face of the first end 113 and a first support 111 and a second support 112. The first and second supports 111, 112 are adapted to moveably support the planar member 136 such that it is held adjacent the first connector 110. In one embodiment, a portion of the face of the first end 113 of the first connector 110 is visible through the ellipse 137 defined in the planar member 136. FIGS. 3A and 4A illustrate the disengaged first locking member 130. In the disengaged position the leg 139 extends relative to the face of the first end 113. The bottom portion 138a of cleft 138 falls below the leg 139.

FIGS. 3B and 4B illustrate the engaged first locking member. The translational force 165 applied to the first locking member 130 causes retraction of the leg 139. The planar member 136 moves in direction 169 and the bottom portion 138a of cleft 138 moves adjacent to and touches leg 139. At least a portion of the ellipse 137, defined within the planar member 136, moves inside at least a portion of groove 121. Groove 121 is disposed about at least a portion of the surface of the second connector 120. The portion of the ellipse 137 disposed inside the portion of groove 121 engages the first connector 110 and the second connector 120 forming the connector assembly 100.

Referring now to FIGS. 3A-3B, the first connector 110 defines a fluid passageway 115 and is optionally configured to prevent fluid flow through the fluid passageway 115 when the first connector 110 is not engaged. In one embodiment, referring now to FIG. 3A, when the first connector 110 is not engaged a valve 180 obstructs the flow of fluid through the fluid passageway 115. At least a portion of the valve 180 prevents the flow of fluid through a first diameter 116 of the fluid passageway 115 of an unengaged first connector 110. For example, the first end 181 (e.g., the diameter of the first end portion 181) of the valve 180 is sized to prevent the flow of fluid through the first diameter 116 when the first connector 110 is unengaged. Referring again to FIGS. 3A and 3B, when the first connector 110 is engaged with a second connector 120 the second connector 120 moves the valve 180 to enable fluid to flow through the fluid passageway 115. For example, the first end 181 of the valve is pushed out of the first diameter 116 and into a second diameter 117, a larger diameter, thereby unblocking the first diameter 116 of the fluid passageway 115 to enable fluid to flow through fluid passageway 115.

In another embodiment, the valve 180 features an o-ring 182 that is sized to prevent fluid from flowing through the first diameter 116 of the fluid passageway 115 of an unengaged first connector 110. When the first connector 110 and the second connector 120 engage, the second connector 120 moves the valve 180. The o-ring 182 disposed on the valve 180 moves into the second diameter 117, a larger diameter, and this movement unblocks the first diameter 116 enabling fluid to flow through the first diameter 116 of the fluid passageway 115. A valve 180 can be adapted to obstruct the flow of fluid through the fluid passageway 115 by any of a variety of configurations known to the skilled person.

The second connector 120 defines a fluid passageway 125 and is optionally configured to prevent fluid flow through the fluid passageway 125 when the second connector 120 is not engaged. In one embodiment, referring now to FIG. 3A, when the second connector 120 is not engaged a valve 190 obstructs the flow of fluid through the fluid passageway 125. The valve 190 has a first end 191 and a second end 193. At least a portion of the valve 190 prevents the flow of fluid through a first diameter 126 of the fluid passageway 125. In one embodiment, the first end 191 (e.g., the diameter of the first end portion 191) of the valve 190 is sized to prevent the flow of fluid through the first diameter 126 of the fluid passageway 125 of an unengaged second connector 120. Referring again to FIGS. 3A and 3B, when the second connector 120 is engaged with a first connector 110, the first connector 110 moves the valve 190 to enable fluid to flow through the fluid passageway 125. For example, the first end 191 of the valve 190 is pushed out of the first diameter 126 and into a second diameter 127, a larger diameter. The first diameter 126 of the fluid passageway 125 is unblocked and fluid is able to flow through the first fluid passageway. In another embodiment, the valve 190 can optionally feature an o-ring (not shown) that is sized to prevent fluid from flowing through the fluid passageway 125 of an unengaged second connector 120. Upon engagement, the first connector 110 moves the valve 190 and the o-ring disposed on the valve 190 thereby unblocking the fluid passageway 125 at, for example, the first diameter 126, enabling fluid to flow therethrough. A valve 190 can be adapted to obstruct the flow of fluid through the fluid passageway 125 by any of a variety of configurations known to the skilled person.

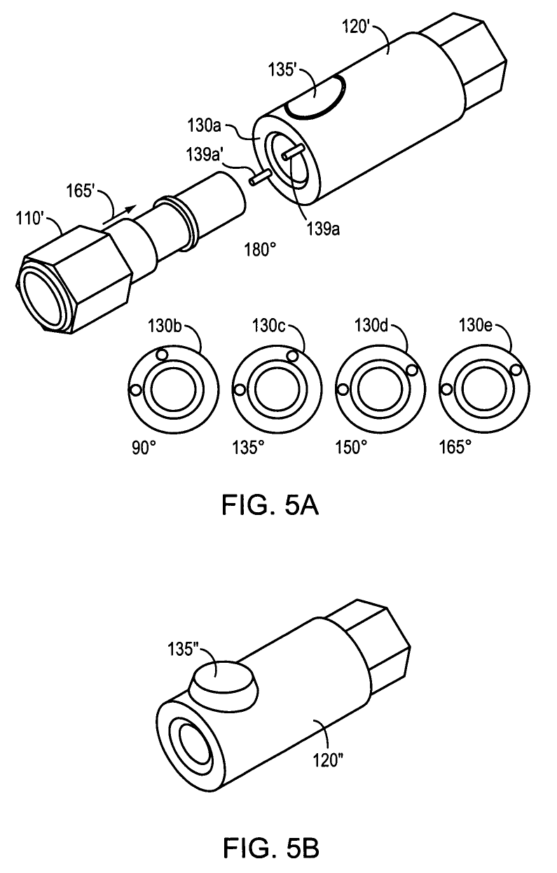

FIG. 5A illustrates another embodiment of a first connector 110′, a second connector 120′, and a locking member 130′ integral to the second connector 120′, A translational force 165′ applied to the locking member 130a by the first connector 110′ engages the first connector 110′ and the second connector 120′ forming a connector assembly. In one embodiment, the touch position 135′ comprises a safety button that is at a level flush with the locking member 130a and/or the second connector 120′, In another embodiment, referring also to FIG. 5B, the touch position 135″ comprises a raised button positioned at a level elevated from the second connector 120″. The first connector 110′, the second connector 120′, and/or the locking member 130a can be positioned and/or designed to avoid incorrect engagement between various fluids, connectors, and/or leads. For example, the one or more of first connector 110′, the second connector 120′, and/or the locking member 130a can be colored to indicate its mated connector and/or locking member. One or more locking member, for example, 130a, 130b, 130c, 130d, and 130e can be designed to only engage with a mated connector. For example, each of two or more legs 139a, 139a′ of locking member 130a are separated by, for example, 180° about the face of the locking member. The legs 139a and 139a′ can be separated by between about 5° and about 180°, by between about 90° and about 165°, or by between about 135° and about 150°.

Suitable first connectors, second connectors, locking members, and/or connector assemblies are disengaged with a single touch, by for example, pressing or touching the touch position (e.g., 135, 135′, 135″) on the connector, locking member, and/or the connector assembly. A connector assembly can have one or more touch position. The first connector and second connector can be engaged by one or more fingers on a single hand that, for example, grasps the second connector and applies a translational force to the locking member. The locking member can be integral to the mated first member. The translational force is applied along a longitudinal axis through the first connector and the mated second connector. The first connector and the second connector can be disengaged by one or more fingers on a single hand that press the touch position and apply a linear force to the touch position at an angle relative to a longitudinal axis along the mated first and second connector. Tools can optionally be used to disengage, however, tools are not required to disengage the connector, locking member, and/or the connector assembly. Accordingly, the power supply and the housing associated with the power supply can be sized and arranged without requiring space for tools to fit and have a necessary range of motion. Rather, the size and arrangement of the power supply accommodates an operator hand to disengage a connector, a locking member, and/or a connector assembly. The placement of the connector, locking member, and/or connector assembly on the power supply is accordingly more flexible then when the connector, locking member, and/or connector assembly requires tools. For example, one or more operator fingers can be used to disengage the connector. Accordingly, the line 105 can be detached from the power supply with a single hand or one or more fingers when using a connector, a locking member, and/or a connector assembly of the present invention. Thus, the power supply and/or the associated housing requires less access space then connectors, locking members, and connector assemblies requiring tools for disengagement. In some embodiments, the connector, the locking member, and/or the connector assembly are designed for frequent and multiple engagements and disengagements. The connector(s), locking members, and/or connector assembly employed in accordance with the present invention require less time for disengagement when compared with disengagements requiring tools. For example, an operator using tools disengaged four lines with threaded connectors from a power supply in two minutes. The same operator using one or more fingers on a single hand disengaged four lines having a touch position from a power supply in thirty seconds. Accordingly, the connectors of the invention provided a four fold improvement in the time required to disengage for lead connectors from a power supply.

Suitable connectors, locking members, and/or connector assemblies that can be used in accordance with the present invention are available from, for example, Colder Products Company (St. Paul, Minn), Staubli Corporation (Duncan, S.C.), and Parker Quick Coupling Division (Minneapolis, Minn). Exemplary connectors and connector assemblies available from Colder Products Company include LC Series, NS4 Series, PMC Series, PLC Series, and MC Series. Suitable connectors and connector assemblies available from Stäubli Corporation include RBE and RBE03 quick release couplings. Suitable connectors and connector assemblies available from Parker's Quick Coupling Division include Hydraulic Quick Couplings.

The connector, locking member, and/or the connector assembly made be made from any suitable materials including, for example, metals (e.g., brass, chrome plated brass, stainless steel, and chrome), plastics (e.g., acetal), a combination of metals and polymers, metal and copolymers, and metal and polymer composites.

A LC Series connector assembly sourced from Colder Products Company was employed with a plasma arc torch system. Specifically, a first connector was disposed on a first end of a lead and a second connector was disposed relative to a power supply. The first connector and second connector mate along a longitudinal axis and upon application of a translational force form the LC Series connector assembly. The lead and connector assembly were tested by being pulled under a 100 lb axial load (“the 100 lb axial pull test”). During and subsequent to the 100 lb axial pull test, the connector assembly remained engaged and did not release. No lead leakage was observed during or subsequent to the 100 lb axial pull test.

In one embodiment, the first connector, second connector, locking member, and/or the connector assembly are configured to prevent fluid flow through a fluid passageway when not engaged. A valve, for example, or other device can be employed to obstruct the flow of fluid through the fluid passageway. The valve or other device can be made of any suitable materials, for example, metals (e.g., brass, chrome plated brass, stainless steel, and chrome), polymers (e.g., acetal), a combination of metals and polymers, and metal and polymer composites.

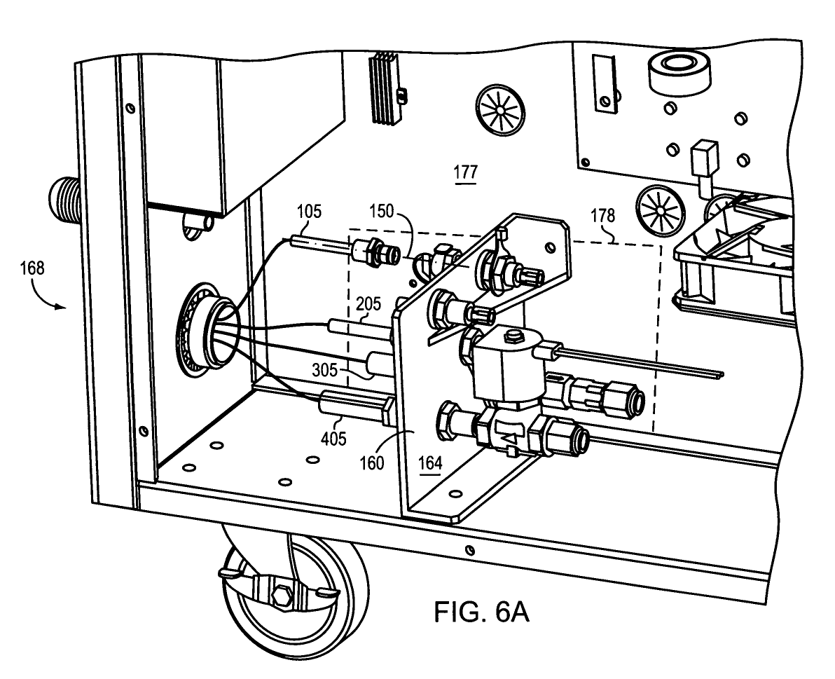

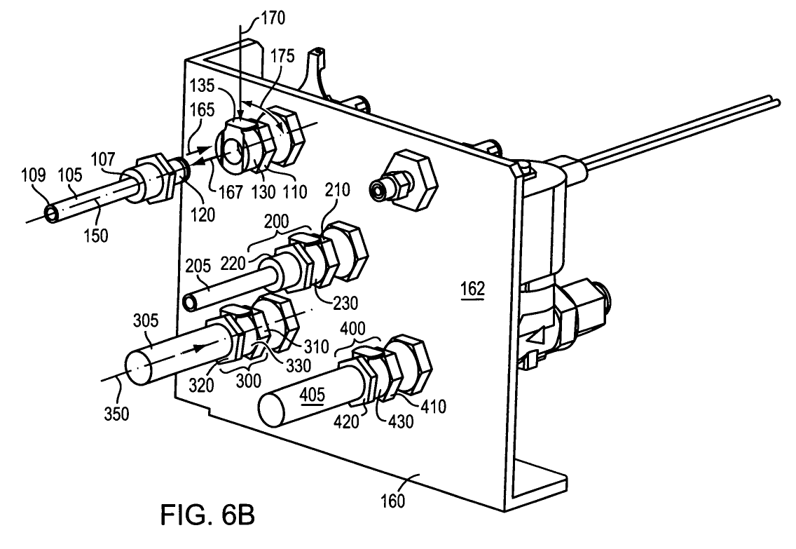

FIGS. 6A-6B illustrate an embodiment where a first lead 105 is disconnected from the housing 160 associated with a power supply 168 and three leads 205, 305, and 405 are connected to the housing 160. In one embodiment, the housing 160 is adjacent the power supply 168. The housing 160 is made from, for example, a non-conducting material (e.g., polymer or plastic), conducting material (e.g., metal), or a combination of non-conducting and conducting materials. A combination of a non-conducting and conducting materials includes, for example, two or more layers of metal and plastic or a panel of metal adjacent a panel of plastic. In one embodiment, the housing 160 is a non-conducting bulkhead. In one embodiment, the housing 160 is a member. In another embodiment (not shown), the connector is disposed relative to a power supply 168 housing. In other embodiments, leads and/or connectors that conduct electricity are connected to a non-conducting housing 160 or to a portion of a housing 160 that is non-conducting.

The power supply 168 housing 160 is provided and the first connector 110 is disposed relative to housing 160 and is adapted to mate, along the longitudinal axis 150, with a second connector 120. In one embodiment, the first connector 110 is disposed on the housing 160. In one embodiment, the first connector 110 is a female connector adapted to mate with a male second connector 120. The female first connector 110 is disposed on the front 162 of the housing 160.

The lead 105 features an elongated body, a first end 107 and a second end 109 opposite the first end 107. The first connector 110 is disposed on the housing 160 and the second connector 120 is disposed on a first end 107 of the first lead 105. Optionally, a torch body (not shown) is disposed on a second end 109 of the lead 105. The second connector 120 is adapted to mate with the first connector 110. In one embodiment, the first locking member 130 is integral to or integrated with the first connector 110. The first connector 110 and the second connector 120 are manipulated relative to the locking member 130 with one of a translational force or a linear force to engage or disengage the first connector 110 and the second connector 120.

Referring now to FIGS. 3A-3B and 6B, in one embodiment, a translational force 165 is applied, along the longitudinal axis 150, to the first locking member 130 by the second connector 120. The translational force 165 applied to the first locking member 130 causes engagement of the first connector 110 and the mated second connector 120. Referring to FIG. 3B, the engaged first connector 110 and second connector 120 form the connector assembly 100. Referring now to FIGS. 3A-3B and 4A-4B, in one embodiment, upon application of the translational force 165 to the first locking member 130 at least a portion of the ellipse 137 disposed inside the portion of groove 121 engages the first connector 110 and the second connector 120. Optionally, a leg 139 retracts when the first connector 110 and the second connector 120 engage.

The first locking member 130 can disengage the first connector 110 and the second connector 120. Referring now to FIGS. 4A and 6B, in one embodiment, a linear force 170 is applied to the first locking member 130 at an angle 175 relative to the longitudinal axis 150. The application of the linear force 170 at the angle 175 causes disengagement of the first connector 110 and the second connector 120. Referring also to FIG. 4A, in one embodiment, upon application of a linear force 170 to a touch position 135 the planar member 136 is moved and the ellipse 137 and the groove 121 are disengaged. Optionally, the linear force 170 is applied to the touch position by one or more fingers or, for example, a operator's hand.

In one embodiment, the angle 175 ranges from about 0° to about 180° relative to the longitudinal axis 150. In another embodiment, the angle 175 ranges from about 45° to about 135° relative to the longitudinal axis 150. In still another embodiment, the angle 175 measures about 90° relative to the longitudinal axis 150. In another embodiment, the angle 175 is perpendicular to the longitudinal axis 150.

Referring again to FIGS. 6A-6B, a third connector 210 is disposed relative to the housing 160 and is adapted to mate with the fourth connector 220. For example, the third connector 210 is disposed on the housing 160. A second locking member 230 engages the third connector 210 and the fourth connector 220 forming a second connector assembly 200. The fourth connector 220 is disposed on an end of the second lead 205 and the second connector assembly 200 connects the second lead 205 to the housing 160 associated with the power supply 168. In one embodiment, a translational force applied to the second locking member 230 by the fourth connector 220 engages the third connector 210 and the fourth connector 220. A connector disposed on the housing is optionally a male connector adapted to fit inside of a mated female connector disposed on an end of a lead.

A fifth connector 310 is disposed relative to the housing 160 and is adapted to mate with the sixth connector 320. In one embodiment, the fifth connector 210 is disposed on the housing. A third locking member 330 engages the fifth connector 310 and the sixth connector 320, forming a third connector assembly 300. The sixth connector 320 is disposed on an end of the third lead 305 and the third connector assembly 300 connects the third lead 305 to the housing 160. In one embodiment, a translational force applied to the third locking member 330 by the fifth connector 310 engages the fifth connector 310 and the sixth connector 320.

A seventh connector 410 is disposed on the housing 160 and is adapted to mate with the eighth connector 420. The fourth locking member 430 engages the seventh connector 410 and the eighth connector 420, forming a fourth connector assembly 400. The eighth connector 420 is disposed on an end of the fourth lead 405 and the fourth connector assembly 400 connects the fourth lead 405 to the housing 160 associated with the power supply 168. A translational force applied to the fourth locking member 430 engages the seventh connector 410 and the eighth connector 420.

Referring now to FIG. 6B, in one embodiment, the linear force 170 is applied to the touch position 135 on the first locking member 130. The linear force 170 applied to the touch position 135 is applied at an angle 175 relative to the longitudinal axis 150. The first connector 110 and the second connector 120 disengage upon application of the linear force 170 applied to the touch position. Referring also to FIGS. 3A-3B, and 4A-4B, as a result of the force 170 applied to the touch position 135, the at least a portion of the ellipse 137 is separated from the groove 121 disposed about the second connector 120 thereby disengaging the connector assembly 100 formed by the first connector 110 and the second connector 120. Optionally, a leg 139 extends from the first locking member 130 and pushes the second connector 120 away from the first locking member 130. Referring again to FIGS. 6A-6B, in an exemplary embodiment, locking members 130, 230, 330, 430 each feature a touch position that, upon application of a linear force applied at an angle relative to the longitudinal axis of the respective connector assembly 100, 200, 300, 400 disengages the connector assembly.

One or more of the connectors each defines a fluid passageway and is optionally configured to prevent fluid flow through the fluid passageway when the connector is not engaged. Suitable fluids that can flow through the fluid passageways include, for example, liquids and gases. In one embodiment, the third connector 210 mounted on or associated with the power supply is configured to prevent fluid flow through its fluid passageway when the connector 210 is not engaged. This prevents fluid from continuing to be supplied when the third connector 210 is not connected to its mated fourth connector 220, avoiding fluid waste, dirtying the work area, and risking a hazardous work area. In one embodiment, the mated fourth connector 220 has a fluid passageway that allows fluid to flow when the fourth connector 220 is not engaged. Alternatively, the third connector 210 and the mated fourth connector 220 are each configured to prevent fluid flow through their fluid passageways when the connectors 210 and 220 are not engaged. A fourth connector 220 configured to prevent fluid flow through its passageway avoids fluid remaining in a removed lead 205 from exiting the lead 205. Optionally, the power supply 168 has a shut off valve that stops the flow of fluids through the power supply. The shut off valve can be manually actuated by, for example, the operator. Alternatively, the shut off valve can be automatically actuated according to feedback from the plasma arc torch.

Referring still to FIGS. 6A-6B, in one embodiment both gas and liquid flow through the leads. For example, gas flows through the first connector assembly 100 and through the first lead 105, gas flows through the second connector assembly 200 and through the second lead 205, liquid flows through the third connector assembly 300 and through the third lead 305, and liquid also flows through the fourth connector assembly 400 and through the fourth lead 405. For example, the liquid flowing through the fourth connector assembly 400 and through the fourth lead 405 is directed from the power supply 168 toward the fourth lead 405 and the liquid flowing through the third lead 305 and through the third connector assembly 300 is directed from the third lead 305 toward the power supply 168. The liquid can be, for example, a coolant supplied from the power supply 168 to a cool a torch through the fourth lead 405 and the coolant returns from the torch to the power supply 168 through the third lead 305. For example, air is supplied from the power supply 168 to the torch through the second lead 205 and nitrogen is supplied from the power supply 168 to the torch through the first lead 105.

In another embodiment, the leads and/or the connector assemblies are designed to avoid incorrectly engaging the leads with, for example, the wrong connector assembly or with an incorrect fluid source. Leads and/or connectors can be sized, colored, or positioned to avoid incorrect engagement. For example, leads that transport gases can be sized differently then leads that transport liquids. Additionally, leads that supply coolant liquid from the power supply can be sized differently then leads that return coolant liquid to the power supply. Leads that supply one fluid can be a first size and leads that supply another fluid are a second size. Optionally, leads are color coded to indicate the fluid they transport. Connectors can similarly be color coded to indicate their mated connector and/or the fluid that they transport. Alternatively, or in addition, the mated connectors that form a connector assembly can be designed or positioned to avoid incorrect engagement. For example, in an embodiment where the third lead 305 and the fourth lead 405 transport coolant, the fifth connector 310, which is disposed on the front 162 of housing 160, is a female connector and the seventh connector 410, also disposed on the front 162 of housing 160, is a male connector. The complimentary sixth connector 320 avoids incorrect engagement because it is a male connector that is unable to mate with the seventh connector 410, also a male connector. Other design options that avoid incorrect engagement include, for example, varying materials, textures, size of connector assemblies, and other design options known to the skilled person. Optionally, keys and/or keysets can be employed to avoid incorrect engagement. The number of connector assemblies, the position of one or more connector assembly on the housing associated with the power supply, the type and/or design of connector assembly, and the type of fluid flowing through each lead connected by each connector assembly will be selected in accordance with the specific power supply.

Optionally, the leads provide an electrical conduit from the power supply to the plasma arc torch. For example, the connectors and the lead each contain a conductive material that carries electrical power at high D. C. current levels, at high voltages and/or high frequencies. Suitable conductive materials include, for example, metals, metal polymer combinations, and metal polymer composites. Suitable conductive connector and lead materials and designs that can be employed in accordance with the instant invention are disclosed in U.S. Pat. No. 5,074,802 to Gratziani et al. entitled Pneumatic-Electric Quick Disconnect Connector for a Plasma Arc Torch, which is incorporated by reference herein.

In another embodiment, a mechanized power supply features only a single lead. Suitable leads can be made from various materials such as, for example, metals (e.g., brass, chrome plated brass, stainless steel, and chrome), polymers (e.g., acetal), a combination of metals and polymers, a combination of metals and copolymers, and metal and polymer composites.

In one embodiment, referring again to FIGS. 6A and 8, the power supply 168, 168′ housing features an opening member 178, 178′, The opening member 178, 178′ enables access one or more connector and/or connector assembly located on the power supply 168, 168′ housing. Optionally, the opening member 178, 178′ enables access to the inside of the power supply 168, 168′ without removing a portion of a cover 177, 177′ from the power supply 168, 168′ housing. In one embodiment, the opening member is a door that enables access to one or more connector and/or connector assembly. Alternatively, at least a portion of a cover 177, 177′ of the power supply 168, 168′ housing is removed by, for example, removing screws or other suitable fasteners that secure the cover 177, 177′ to the power supply 168, 168′ housing.

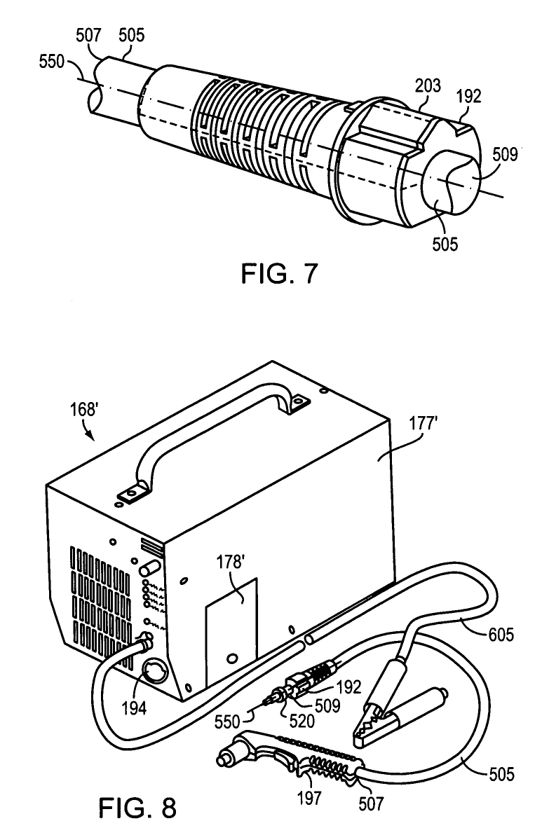

FIG. 7 depicts a positive rotational restraint component 192 and FIG. 8 depicts a plasma arc torch system including a power supply 168′, a lead 505, a connector 520, a positive rotational restraint component 192, and a torch body 197 used for cutting or piercing a metal work piece. The positive rotational restraint component 192 restrains rotational movement of the lead 505 relative to the power supply 168′ housing. The positive rotational restraint component 192 can be disposed, for example, adjacent a connector 520, adjacent a connector assembly, or on the lead 505.

In one embodiment, a positive rotational restraint component 192 is disposed on the elongated body of the lead 505 and the positive rotational restraint component 192 restrains rotational movement of the lead 505 relative to the power supply 168′, In another embodiment, the second end 509 of the lead 505 is disposed on the power supply 168′. In another embodiment, the second end 509 of the lead 505 is adjacent a connector 520. The positive rotational restraint component 192 can be independent from the connector 520. As described above, in one embodiment, the connector 520 engages with a mated connector positioned on a housing, such as, referring to FIGS. 3A-3B, 4A-4B, and 6A-6B, the housing member 160 located inside the power supply 168 housing. The connector 520 defines a fluid passageway and is optionally configured to prevent fluid flow through the fluid passageway when the connector 520 is not engaged. The connector 520 can form a connector assembly with a mated connector. A locking member integral to or separate from the connector 520 can, upon application of a translational force, engage the connector 520 with a mated connector to form a connector assembly. The application of a linear force to the locking member at an angle relative to the longitudinal axis 550 causes disengagement of the connector 520 and its mated connector. The mated connector can define a fluid passageway and is optionally configured to prevent fluid flow through the fluid passageway when the connector 520 and the mated connector are not engaged.

In one embodiment, the positive rotational restraint component 192 includes a shaped boot 203 attached to the lead 505. In another embodiment, the positive rotational restraint component 192 includes the shaped boot 203 and a mating receptacle 194 formed in the power supply 168′ housing. The shaped boot 203 and the mating receptacle 194 are designed to prevent rotation of the lead 505 when the shaped boot 203 is inserted in the mating receptacle 194. The shaped boot 203 and mating receptacle 194 are designed to have anti-rotation features to prevent rotation of the lead 505 relative to the power supply 168′ housing. In another embodiment (not shown), multiple leads (e.g., more than one fluid lead) are disposed through the positive rotational restraint component 192 through, for example, the shaped boot 194.

The positive rotational restraint component 192 is arranged in a spaced relationship relative to a longitudinal axis 550 of the lead 505. In addition, the connector 520 and the positive rotational restraint component 192 can be configured so that both are engaged simultaneously when the lead 505 is connected to the power supply 168′ housing by, for example, engagement of the connector 520 with its mated connector.

FIG. 8 illustrates a plasma arc torch system representative of any of a variety of models of torch systems. A torch body 197 configured for hand cutting is connected to the power supply 168′ by a single lead 505. The power supply 168′ is enclosed by a housing. The lead 505 is connected to the power supply 168′ by a connector 520. The positive rotational restraint component 192 prevents rotation of the lead 505 relative to the power supply 168′ housing when the positive rotational restraint component 192 is inserted into the mating receptacle 194. The lead 505 provides the torch body 197 with a plasma gas from a gas source (not shown) and electrical power from the power supply 168′ to ignite and sustain a plasma stream. In one embodiment, air is used as the plasma gas, but other gases can be used to improve cut quality on metals such as stainless steel and aluminum. A workpiece lead 605 provides a return path for the current generated by the power supply 168′ and is typically connected to a workpiece (not shown) by a clamp 225.

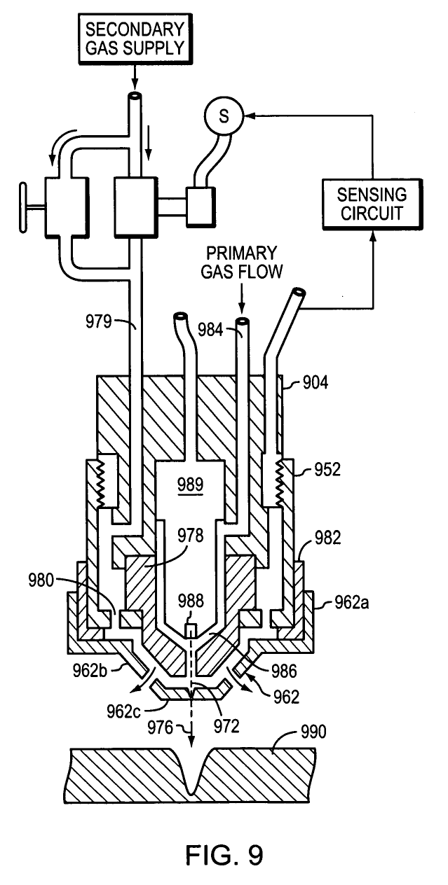

FIG. 9 illustrates, in simplified schematic form, a plasma arc torch representative of any of a variety of models of torches. For example, the plasma arch torch system described in conjunction with FIG. 8 can include the features described in conjunction with FIG. 9. The torch has a body 904 which is generally cylindrical with an exit orifice 972 at a lower end. A plasma arc 976, i.e. an ionized gas jet, passes through the exit orifice 972. The torch is used to pierce and cut metal, such as mild steel or other electrically-conducting materials, in a transferred arc mode. In cutting mild steel, the torch operates with a reactive gas, such as oxygen or air, or a non-reactive gas, such as nitrogen or argon, as the plasma gas to form the transferred plasma arc.

The torch body 904 supports an electrode 989 having an insert 988 in its lower end and a nozzle 978 spaced from the electrode 989. The nozzle 978 has a central orifice that defines the exit orifice 972. In operation, the plasma gas flows through a plasma gas inlet tube 984. The plasma gas flows into the plasma chamber 986 and out of the torch through the exit orifice 972. A pilot arc, which ionizes the plasma gas passing through the exit orifice 972, is first generated between the electrode 989 and the nozzle 978. The arc then transfers from the nozzle 978 to a workpiece 990. A retaining cap 952 substantially encloses the outer surface of the nozzle 978 and is mounted on the torch body 904. A shield 962 (i.e., 962a, 962b, and 962c) has a central circular opening and is aligned with the nozzle 978. An insulating ring 982 can be disposed between the retaining cap 952 and the shield 962. In one embodiment, (not shown) a swirl ring is mounted to the torch body 904, optionally, the swirl ring 980 has a set of radially offset (or canted) gas distribution holes that impart a tangential velocity component to the plasma gas flow causing it to swirl. This swirl creates a vortex that constricts the arc and stabilizes the position of the arc on the insert. In another embodiment, a secondary gas 979 flows through the torch 904 and passes through space between the nozzle 978 and the shield 962 to provide cooling ports 980 (e.g., canted ports) in the secondary gas 979 flow path, producing a swirling flow that improves cut quality. Other torches can be cooled by liquid such as, for example, water or a water mixture. The particular construction details of the torch body, including the arrangement of components directing of plasma gas, secondary gas, and cooling fluid flows and providing electrical connections can take a wide variety of forms.

The lead between the torch and the power supply can be disconnected from the power supply when repairing or replacing the torch head or the lead. For example, the lead is disconnected from the power supply by applying a linear force to a connector assembly locking member at an angle relative to a longitudinal axis of the connector assembly. In addition, an operator often disconnects the torch from the power supply for convenience during storage or transport of the system. The connector, locking member, and/or connector assembly disposed relative to the housing associated with the power supply can be frequently engaged and/or disengaged without tools, without wear or leakage. The connector, locking member, and/or connector assembly can be engaged and/or disengaged in a short period of time relative to other connectors that, for example, require tools. The connector, locking member, and/or connector assembly avoid incorrect tightening and/or installation that is possible with other connectors that, for example, are threaded.

### EQUIVALENTS

While the invention has been particularly shown and described with reference to specific preferred embodiments, it should be understood by those skilled in the art that various changes in form and detail can be made therein without departing from the spirit and scope of the invention as defined by the appended claims. For example, alternative connector structures that require translational force for engagement and a linear force for disengagement of connectors disposed, for example, on an end of a lead and on the power supply are within the scope of the invention. A connector structure defines a fluid passageway and is alternatively configured to prevent fluid flow through the fluid passageway when the connector is not engaged.

1. A power supply for a plasma arc system, the power supply comprising:
a housing associated with the power supply;
a first connector disposed relative to the housing and adapted to mate with a second connector along a longitudinal axis;
a locking member causing, upon application of a translational force, engagement of the first connector and the second connector, the locking member causing, upon application of a linear force at an angle relative to the longitudinal axis, disengagement of the first connector and the second connector.

2. The power supply of claim 1 further comprising an opening member to access the first connector, the second connector, or the first connector and the second connector.

3. The power supply of claim 1 wherein the locking member further comprises a planar member adapted to disengage the first connector and a second connector upon application of a linear force applied to the planar member at an angle perpendicular to the longitudinal axis.

4. The power supply of claim 1 wherein the first connector is a female connector or a male connector.

5. The power supply of claim 1 wherein the locking member is integral to the first connector.

6. The power supply of claim 1 wherein the locking member is integral to the second connector.

7. The power supply of claim 1 further comprising a third connector disposed relative to the housing and adapted to mate with a fourth connector along a second longitudinal axis, a second locking member causing, upon application of a translational force, engagement of the third connector and the forth connector, the second locking member causing, upon application of a linear force at an angle relative to the second longitudinal axis, disengagement of the third connector and the fourth connector.

8. The power supply of claim 7 wherein the first connector is a female connector and the third connector is a male connector.

9. The power supply of claim 1 wherein the first connector defines a fluid passageway and is configured to prevent flow through the fluid passageway when the first connector is disengaged.

10. A lead for a plasma arc torch, the lead comprising an elongated body, a first end, and a second end;
a second connector disposed on the second end of the lead; and
a locking member causing, upon application of a translational force along a longitudinal axis, engagement of the second connector and a first connector, the locking member causing, upon application of a linear force at an angle relative to the longitudinal axis, disengagement of the first connector and the second connector.

11. The lead for a plasma arc torch of claim 10 wherein the locking member further comprises a planar member adapted to disengage the first connector and the second connector upon application of a linear force applied to the planar member at an angle perpendicular to the longitudinal axis.

12. The lead for a plasma arc torch of claim 10 wherein the second connector is a female connector or a male connector.

13. The lead for a plasma arc torch of claim 10 wherein the locking member is integral to the second connector.

14. The lead for a plasma arc torch of claim 10 wherein the locking member is integral to the first connector.

15. The lead for a plasma arc torch of claim 10 wherein the second connector defines a fluid passageway and is configured to prevent flow through the fluid passageway when the second connector is disengaged.

16. A plasma arc torch system comprising:
a torch body;
a power supply;
a lead comprising an elongated body, a first end connects to the torch body, and a second end;
a connector assembly connecting the second end of the lead with the power supply, the assembly comprising a first connector adapted to mate with a second connector along a longitudinal axis; and
a locking member causing, upon application of a translational force, engagement of the first and second connector, the locking member causing, upon application of a linear force at an angle relative to the longitudinal axis, disengagement of the first and second connector.

17. The plasma arc torch system of claim 16 the torch body further comprising:
a nozzle mounted at a first end of the torch body;
an electrode mounted at a first end of the torch body in a mutually spaced relationship with the nozzle to define a plasma chamber; and
a retaining cap mounted on the torch body and substantially enclosing the outer surface of the nozzle.

18. The plasma arc torch system of claim 17 the torch body further comprising a shield having a central circular opening aligned with the nozzle.

19. The plasma arc torch system of claim 17 the lead further comprising a positive rotational restraint component disposed on the elongated body, the second end of the lead is disposed on the power supply, and the positive rotational restraint component restrains rotational movement of the lead relative to the power supply.

20. A method for connecting and disconnecting a torch lead to a power supply for a plasma arc torch, comprising:
providing a power supply comprising a housing;
disposing relative to the housing a first connector adapted to mate with a second connector;
providing a lead comprising an elongated body, a first end connected to a torch body, and a second end connected to the second connector; and
manipulating the first connector and the second connector relative to a locking member with one of a translational force or a linear force to engage or disengage the first connector and the second connector.

21. The method of claim 20 further comprising:
applying translational force to the second connector along a longitudinal axis; and
engaging the second connector with the first connector.

22. The method of claim 20 further comprising:
applying a linear force to the locking member at an angle relative to a longitudinal axis; and
disengaging the first connector and the second connector.

23. The method of claim 20 further comprising:
applying with one or more fingers a linear force to the locking member at an angle relative to a longitudinal axis; and
disengaging the first connector and the second connector.

24. The method of claim 20 wherein the first connector defines a fluid passageway and is configured to prevent flow through the fluid passageway when the first connector is disengaged.

25. The method of claim 20 wherein the second connector defines a fluid passageway and is configured to prevent flow through the fluid passageway when the second connector is disengaged.

26. A power supply for a plasma arc system, the power supply comprising:
a housing associated with the power supply; and
a first connector disposed relative to the housing, wherein the first connector defines a fluid passageway and is configured to prevent fluid flow through the fluid passageway when the first connector is disengaged from a mated second connector.

27. The power supply of claim 26 wherein the first connector comprises a valve adapted to open and close the fluid passageway.

28. The power supply of claim 26 wherein the second connector defines a second liquid passageway and is configured to prevent flow through the second liquid passageway when the second connector is disengaged from the first connector.

29. The power supply of claim 26 further comprising a third connector disposed relative to the housing and adapted to mate with a fourth connector.

30. The power supply of claim 29 wherein the third connector defines a gas passageway and is configured to prevent flow through the gas passageway when the third connector is disengaged from the fourth connector.

31. The power supply of claim 29 wherein the first connector defines a liquid passageway and the third connector defines a gas passageway.

32. The power supply of claim 31 further comprising a fifth connector disposed relative to the housing, defining a third liquid passageway, and configured to prevent flow through the third liquid passageway when the fifth connector is disengaged from a mated sixth connector.

33. The power supply of claim 31 further comprising a seventh connector disposed relative to the housing and defining a third gas passageway.

34. The power supply of claim 29 wherein the first connector is a female connector and the third connector is a male connector.

35. The power supply of claim 29 wherein the first connector comprises a first color and the third connector comprises a second color different from the first color.

36. A lead for a plasma arc torch, the lead comprising an elongated body, a first end, and a second end; and
a second connector disposed on the second end of the lead defines a fluid passageway and is configured to prevent fluid flow through the fluid passageway when the second connector is disengaged from a mated first connector.

37. The lead of claim 36 wherein the second connector comprises a valve adapted to open and close the fluid passageway.

38. A plasma arc torch system comprising:
a torch body;
a power supply;
a lead comprising an elongated body, a first end connected to the torch body, and a second end; and
a connector assembly connecting the second end of the lead with the power supply, the assembly comprising a first connector defining a fluid passageway and configured to prevent fluid flow through the fluid passageway when the first connector is disengaged from a mated second connector.

39. The plasma arc torch system of claim 38 the torch body further comprising:
a nozzle mounted at a first end of the torch body;
an electrode mounted at a first end of the torch body in a mutually spaced relationship with the nozzle to define a plasma chamber; and
a retaining cap mounted on the torch body and substantially enclosing the outer surface of the nozzle.

40. The plasma arc torch system of claim 39 the torch body further comprising:
a shield having a central circular opening aligned with the nozzle.

41. The plasma arc torch system of claim 38 the lead further comprising a positive rotational restraint component disposed on the elongated body, the second end of the lead is disposed on the power supply, and the positive rotational restraint component restrains rotational movement of the lead relative to the power supply.

42. A method for connecting a torch lead to a power supply for a plasma arc torch, comprising:
providing a power supply comprising a housing;
disposing relative to the housing a first connector adapted to mate with a second connector;
providing a lead comprising an elongated body, a first end connected to a torch body, and a second end;
disposing on the second end of the lead the second connector defining a fluid passageway and configured to prevent fluid flow through the fluid passageway when the second connector is disengaged from the first connector; and
engaging the first connector and the second connector.

43. The method of claim 42 wherein the first connector defines a second fluid passageway and is configured to prevent fluid flow through the second fluid passageway when the second connector and the first connector are disengaged.

44. A power supply for a plasma arc system, the power supply comprising:
a housing means associated with the power supply;
a first connector means disposed relative to the housing and adapted to mate with a second connector means along a longitudinal axis;
a locking means causing, upon application of a translational force, engagement of the first connector means and the second connector means, the locking means causing, upon application of a linear force at an angle relative to the longitudinal axis, disengagement of the first connector means and the second connector means.
